(19) United States
(12) Patent Application Publication
(10) Pub. No.: US 2025/0019160 A1
(43) Pub. Date: Jan. 16, 2025

(54) APPARATUSES INCLUDING A DUMPSTER AND A MOVEABLE SLEDGE

(71) Applicant: Ryan Drury, Durand, MI (US)

(72) Inventor: Ryan Drury, Durand, MI (US)

(21) Appl. No.: 18/769,526

(22) Filed: Jul. 11, 2024

Related U.S. Application Data
(60) Provisional application No. 63/513,211, filed on Jul. 12, 2023.

(51) Int. Cl. B65F 7/00; B08B 1/16; B08B 1/30; B65F 1/14

(52) U.S. Cl. CPC B65F 7/005; B08B 1/165; B08B 1/30; B65F 1/1473

(57) ABSTRACT

An apparatus for transporting waste material and removing residue from its interior including a dumpster and a sledge. The dumpster includes a floor having an interior surface, an exterior surface opposite the interior surface, a front end, and a rear end, a first sidewall, a second sidewall, an end wall, a door wall, and a rail. The sledge includes an upstanding wall having a front side and a back side, a scraper extending at an oblique angle from the front side of the upstanding wall and contacting the interior surface of the floor, and a mount provided on the upstanding wall and engaging the rail to permit the sledge to move from a retracted position proximate the rear end of the end wall to an extended position proximate the front end of the floor.

### CROSS-REFERENCE TO RELATED APPLICATION

This application claims the benefit of co-pending U.S. Provisional Patent Application No. 63/513,211, filed Jul. 12, 2023, for “Dumpsters Including A Moveable Sledge,” which is hereby incorporated by reference in its entirety including the drawings.

### TECHNICAL FIELD

The present specification generally relates to dumpsters and, more specifically, roll-off dumpsters.

### BACKGROUND

Dumpsters may be utilized for transporting a variety of materials. Some of the materials placed in the dumpster may adhere to an interior surface of the dumpster or can leave behind a residue that adheres to the interior surface. Previous solutions for removing such residue have included installing a liner that covers the interior surface of the dumpster before placing material in the dumpster. Such a liner can then be disposed of after the material is removed from the dumpster. However, liners are time-consuming to install and involve an added cost as each liner can only be used once.

Accordingly, a need exists for improved dumpsters including a reusable mechanism for removing residue from the interior surface of the dumpster.

### SUMMARY

The present application describes apparatuses for the storage and transporting waste material including a dumpster, such as for example, a roll-off dumpster, and a sledge or wall movably provided within the dumpster, which can be shaped to closely conform to an interior surface of the dumpster, and that has rollers, a rope, and/or any other suitable device to allow the sledge to move from a rear end of the dumpster to a front end of the dumpster. It will be appreciated that in some embodiments the act of raising and tilting the rear end of the dumpster upward allows gravity to urge the sledge from the rear end of the dumpster downward, and toward the front end of the dumpster to assist in expelling out of the dumpster any material within the interior thereof, including waste material that may be stuck on the interior surface of the dumpster. In other embodiments, the sledge may be provided as a stand-alone device separate from a dumpster, but may be utilized as a retro-fit into existing dumpsters to add the debris expelling capability to dumpsters that are already in the field.

In one embodiment, an apparatus includes a dumpster and a moveable sledge or wall. The dumpster includes a floor having an interior surface, an exterior surface opposite the interior surface, a front end, and a rear end, a first sidewall having an interior surface and extending upwardly from the floor, a second sidewall having an interior surface and extending upwardly from the floor opposite the first sidewall, an end wall extending between the first sidewall and the second sidewall having an interior surface and extending upwardly from the rear end of the floor a door wall that is movably attached to one of the first sidewall and the second sidewall at the front end of the bottom, and a rail or guide extending along the interior surface of at least one of the first sidewall and the second sidewall between the front end and the rear end of the floor. The sledge may include an upstanding wall having a front side and a back side, and a mount provided on the upstanding wall and engaging the rail to permit the sledge to move from a retracted position proximate the rear end of the end wall to an extended position proximate the front end of the floor, and it may also include a scraper extending at an oblique angle from the front side of the upstanding wall and contacting the interior surface of the floor.

In another embodiment, an apparatus for the storage and transporting waste material includes: a dumpster including: a floor; a pair of opposing sidewalls; a rail provided on and extending substantially a length of each of the sidewalls; an end wall; and a door wall pivotably mounted to at least one of the sidewalls or floor, wherein the floor, the sidewalls, and the end wall define an interior of the dumpster and an open top for the dumpster to permit waste material to be deposited into the dumpster, wherein the door wall is movable between a first position closing the dumpster and a second position to open to the interior of the dumpster; and a sledge positionable within the interior of the dumpster and configured to extend between the sidewalls of the dumpster, the sledge being positioned on the rails and movable along the rails between the end wall and the door wall, wherein when door wall is placed in the second position and the dumpster is inclined, the sledge operates to move toward the door wall and away from the end wall to reject waste material in the interior out of the dumpster.

In yet another embodiment, a sledge may include an upstanding wall having a front side and a back side, a mount provided on at least one side of the upstanding wall where the mount is configured to engage a rail or guide of a dumpster, and it may also include a scraper extending at an oblique angle from the front side of the upstanding wall

These and additional features provided by the embodiments described herein will be more fully understood in view of the following detailed description, in conjunction with the drawings.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, where like structure is indicated with like reference numerals and in which:

FIG. 1 schematically depicts a perspective view of an apparatus including a dumpster tilted upwards with a sledge in an extended position, according to one or more embodiments shown and described herein;

FIG. 2 schematically depicts a top view of the apparatus, according to one or more embodiments shown and described herein;

FIG. 3 schematically depicts a cross-sectional side view of the apparatus taken along line 3-3 of FIG. 2 with the sledge in a retracted position, according to one or more embodiments shown and described herein;

FIG. 4 schematically depicts a cross-sectional view of the dumpster taken along line 4-4 in FIG. 3, according to one or more embodiments shown and described herein;

FIG. 5 schematically depicts a front end view of the apparatus with the sledge in the retracted position, according to one or more embodiments shown and described herein;

FIG. 6 schematically depicts an enlarged view of a rail formed in a sidewall of the dumpster and a roller of the sledge engaging the rail, according to one or more embodiments shown and described herein;

FIG. 7 schematically depicts a perspective view of the sledge, according to one or more embodiments shown and described herein;

FIG. 8 schematically depicts a top view of the apparatus including a locking mechanism; and

FIG. 9 schematically depicts a side view of the apparatus including a linkage member for operating the locking mechanism.

### DETAILED DESCRIPTION

Embodiments described herein are directed to an apparatus including a dumpster, particularly a roll-off dumpster, and a sledge movably engaging the dumpster for clearing debris out of the dumpster.

Various embodiments of the apparatus and the operation of the apparatus are described in more detail herein. Whenever possible, the same reference numerals will be used throughout the drawings to refer to the same or like parts.

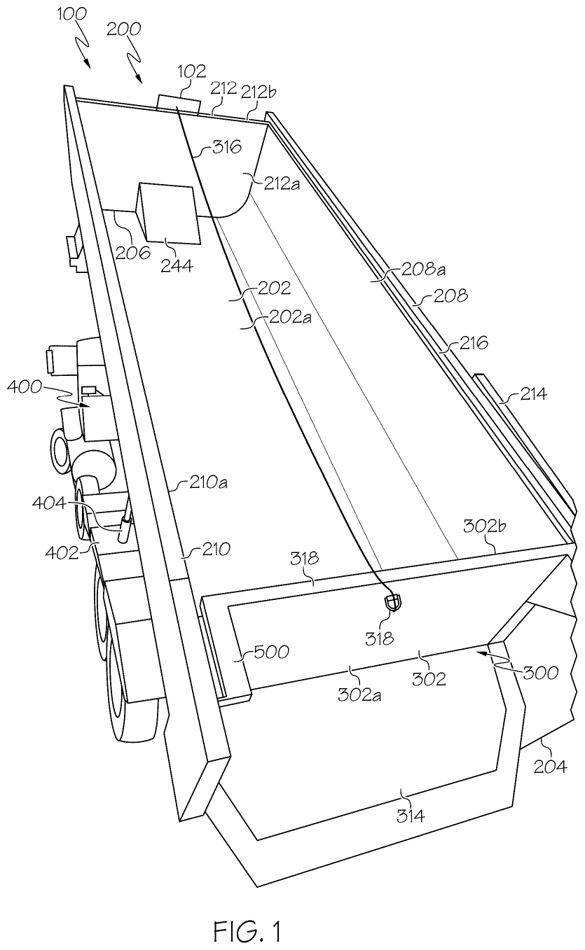

Referring now to FIG. 1, an apparatus 100 is illustrated according to one or more embodiments described herein. The apparatus 100 generally includes a dumpster 200 and a sledge 300. In embodiments, the dumpster 200 may be mounted on a vehicle 400 such as, for example, a truck. In particular, the truck may be a roll-off truck including a bed 402 on which the dumpster 200 is positioned. Accordingly, the dumpster 200 may be configured as a roll-off dumpster. As such, the dumpster 200 is positioned on the bed 402 of the truck and positionable between a stowed position and a dumping position, as shown in FIG. 1, in which the dumpster 200 is tilted relative to the truck to dump contents out of the dumpster 200. Although not described in detail herein, one or more tilt mechanisms 404 such as, for example, actuators, lifts, and the like, are provided on the bed 402 of the truck between the bed 402 and the dumpster 200 to position the dumpster 200 between the stowed position and the dumping position.

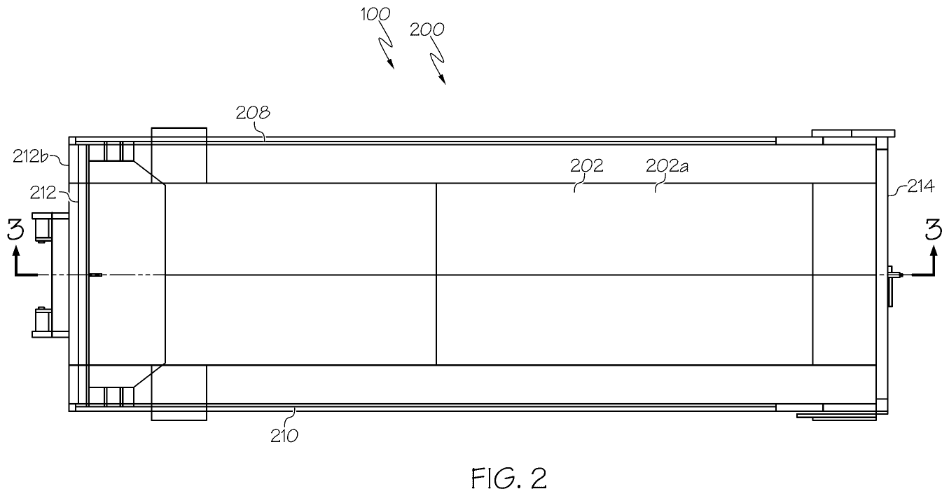

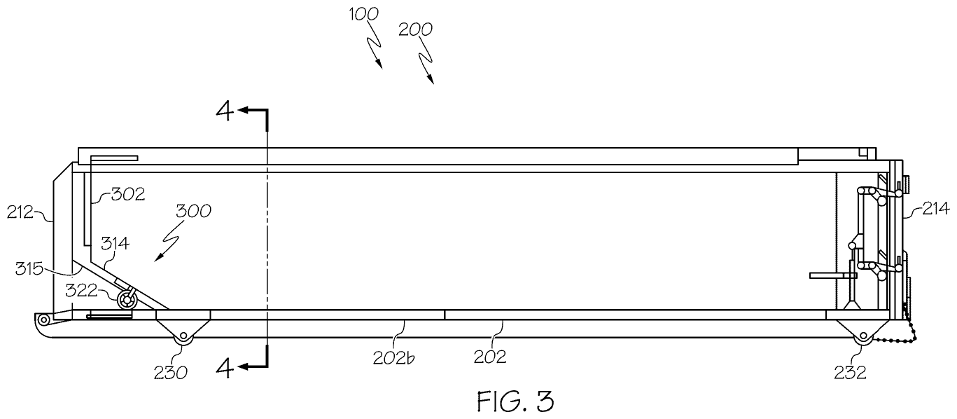

As shown in FIGS. 1 and 2, the dumpster 200 is substantially rectangular in shape. However, it should be appreciated that the dumpster 200 may have any suitable geometry. With more particularity, as shown in FIG. 1, the dumpster 200 may generally include a floor 202 having an interior surface 202a, an exterior surface 202b (FIG. 3) opposite the interior surface 202a, a front end 204, and a rear end 206 opposite the front end 204. The dumpster 200 further includes a first sidewall 208, a second sidewall 210, an end wall 212, a door wall 214, and a rail 216. The first sidewall 208 has an interior surface 208a and extends upwardly from the floor 202. The second sidewall 210 has an interior surface 210a and extends upwardly from the floor 202 opposite the first sidewall 208. The end wall 212 extends upwardly from the rear end 206 of the floor 202 between the first sidewall 208 and the second sidewall 210. The door wall 214 is movably attached to one of the first sidewall 208 and the second sidewall 210 at the front end 204 of the floor 202. The rail 216 extends along the interior surface of at least one of the first sidewall 208 and the second sidewall 210 in a longitudinal direction between the front end 204 and the rear end 206 of the floor 202. The floor 202, the first sidewall 208, the second sidewall 210, and the door wall 214 define an open interior having an open top. In embodiments, the dumpster 200 may include an upper wall such that the top end of the dumpster 200 is concealed. The upper wall may be formed from a rigid material or a flexible material, such as a cloth or the like, to provide coverage for the open interior of the dumpster 200.

As shown in FIG. 1, in embodiments, a protrusion 244 is formed at a junction of the floor 202 and the end wall 212 of the dumpster 200. The protrusion 244 extends between the interior surface 212a of the end wall 212 and the interior surface 202a of the floor 202 at an oblique angle. The protrusion 244 forms an indent in the exterior surface 212b of the end wall 212 and the exterior surface 202b of the floor 202 such that when the dumpster 200 is mounted on the back of the vehicle 400, the dumpster 200 may sit flush with the bed 402 of the vehicle 400. This also leaves room to accommodate components of the vehicle 400 that are mounted on the bed 402 of the vehicle 400. In embodiments, the protrusion 244 has a substantially triangular geometry. However, other shapes are contemplated and within the scope of the present disclosure.

Referring again to FIG. 2, in embodiments, the door wall 214 of the dumpster 200 may be a door pivotally attached to one of the first sidewall 208 and the second sidewall 210, such as by hinges or the like, and positionable between a first or closed position (FIG. 2) and a second or open position (FIG. 1). For example, the first sidewall 208 may include hinges about which the door wall 214 pivots and the second sidewall 210 may include a latch engaging a lock of the door wall 214. Accordingly, the lock of the door wall 214 may engage the latch of the second sidewall 210 to maintain the door wall 214 in the first position. Once the lock disengages the latch, the door wall 214 may be permitted to rotate into the second position. In other embodiments, the door wall 214 is slidably attached to one of the first sidewall 208 and the second sidewall 210 such that the door wall 214 slides between the first position and the second position to provide access to the open interior of the dumpster 200. For example, the first sidewall 208, the second sidewall 210, or the floor 202 may include sliders engaged by the door wall 214 such that the door wall 214 is slidably moveable between the first position and the second position.

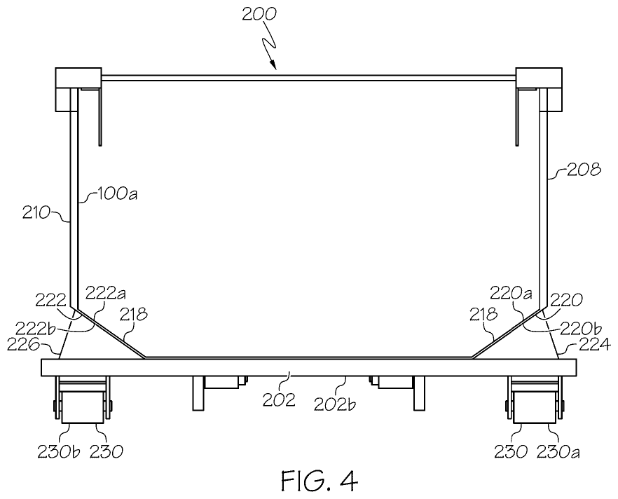

Referring now to FIG. 3, a cross-sectional side view of the dumpster 200 is shown with the door wall 214 in the first position. In embodiments, the dumpster 200 includes one or more wheels mounted on the exterior surface 202b of the floor 202. As shown, one or more back wheels 230 are provided proximate the end wall 212 of the dumpster 200 and one or more front wheels 232 are located proximate the door wall 214 of the dumpster 200. In embodiments, a pair of back wheels 230 and a pair of front wheels 232 are provided. The back wheels 230 be spaced apart in a lateral direction extending perpendicular to the longitudinal direction, as shown in FIG. 4. As shown in FIG. 4, the pair of back wheels 230 are shown provided on the exterior surface 202b of the floor 202. Specifically, the back wheels 230 are spaced apart from one another such that a first back wheel 230a of the pair of back wheels 230 is provided under the first sidewall 208 and a second rear wheel 230b of the pair of back wheels 230 is provided under the second sidewall 210.

Referring again to FIG. 3, the front wheels 232 may also be spaced apart in the lateral direction. The back wheels 230 and the front wheels 232 permit the dumpster 200 to be transported and rolled onto the bed 402 of the vehicle 400 (FIG. 1). In addition to providing a way for transporting the dumpster 200 by rolling it, the back wheels 230 and the front wheels 232 also space the floor 202 from a ground surface when not positioned on the bed 402 of the vehicle 400 by an offset distance. This offset distance creates enough space for a lifting mechanism of a forklift or other materials handling machinery to be inserted under the dumpster 200 and lift the dumpster 200 so that it may be transported.

Referring again to FIG. 4, in embodiments, the first sidewall 208 includes a first offset wall 220 having an interior surface 220a and an exterior surface 220b. The first offset wall 220 extends at an oblique angle from the floor 202. The second sidewall 210 includes a second offset wall 222 having an interior surface 222a and an exterior surface 222b. The second offset wall 222 extends at an oblique angle from the floor 202 at a side opposite the first offset wall 220. A first support wall 224 extends outwardly at an oblique angle from the exterior surface 222b of the first offset wall 220 to the floor 202. A second support wall 226 extends outwardly at an oblique angle from the exterior surface 222b of the second offset wall 222 to the floor 202. In embodiments, a region between the first offset wall 220, the first support wall 224, and the floor 202 is substantially triangular. Similarly, in embodiments, the region between the second offset wall 222, the second support wall 226, and the floor 202 is also substantially triangular.

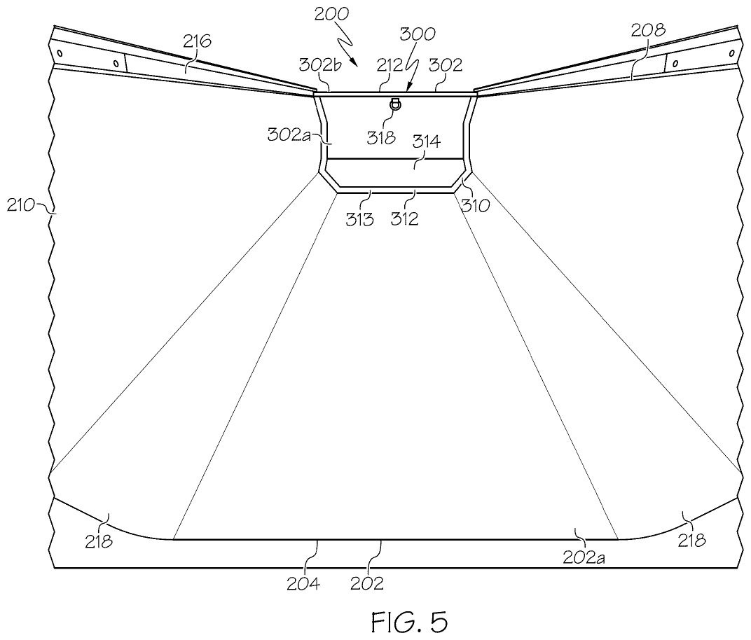

Referring now to FIG. 5, in embodiments, corners of the interior surface 202a of the floor 202 of the dumpster 200 that are formed between the first sidewall 208 and the floor 202, and the second sidewall 210 and the floor 202 are inner chamfered corners 218. In other embodiments, the corners may be rounded. Having these corners as an inner chamfered or rounded surface makes the interior of the dumpster 200 substantially U-shaped to create a profile that is easier to remove debris from.

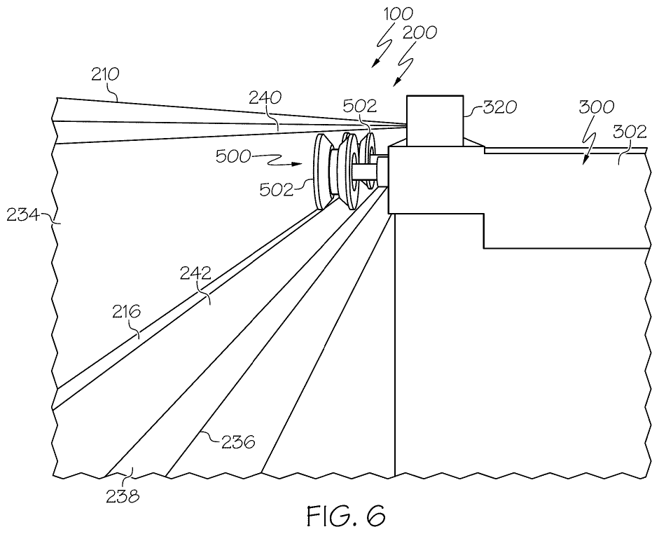

Referring now to FIG. 5, the rail 216 is provided on or in at least one of the first sidewall 208 and the second sidewall 210 and extends in the longitudinal direction between the front end 204 and the rear end 206 of the floor 202. In embodiments, a rail 216 is provided on each of the first sidewall 208 and the second sidewall 210. It should be appreciated that the rails 216 formed in each of the first sidewall 208 and the second sidewall 210 have similar structure. Thus, only the rail 216 formed in the second sidewall 210, illustrated in more detail in FIG. 6, is described herein. However, it should be appreciated that the description of the rail 216 of the first sidewall 208 is equally applicable to the rail 216 of the second sidewall 210 illustrated in FIG. 6.

As shown in FIG. 6, in embodiments, the rail 216 extends an entire length of the first sidewall 208. In embodiments, the rail 216 defines a recess 234 formed in the second sidewall 210. The recess 234 extends an entire length of the second sidewall 210. In embodiments, the recess 234 has a lower surface 236 and an indentation 238 formed in the lower surface 236 to define a V-shaped rib 242. The recess 234 also has an upper surface 240. In other embodiments, the rail 216 defines a cylindrically shaped channel. In other embodiments, the rail 216 includes a worm gear operated by a motor, as discussed herein.

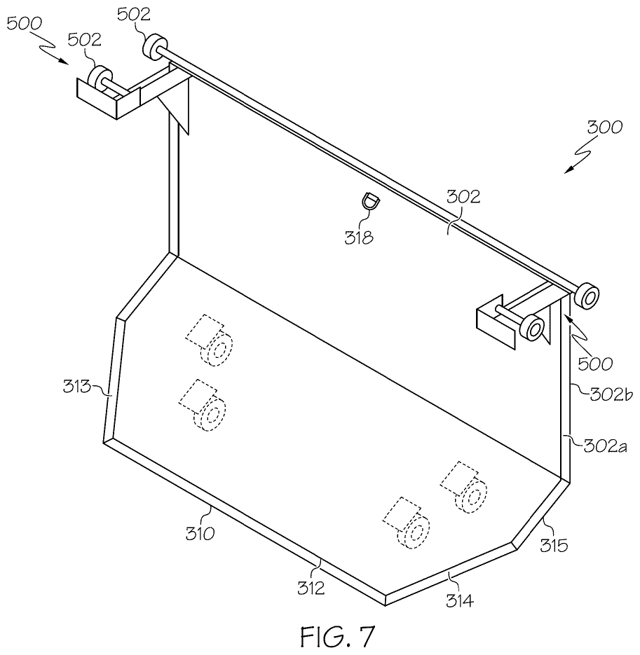

Referring again to FIG. 1, as described herein, the apparatus 100 includes a sledge 300. The sledge 300 includes an upstanding wall 302 having a front side 302a and a back side 302b, and a scraper 314 extending at an oblique angle from the front side 302a of the upstanding wall 302 and contacting the interior surface 202a of the floor 202. The sledge 300 also includes a mount 500 (FIG. 7) provided on the upstanding wall 302 and engaging the rail 216 to permit the sledge 300 to move from a retracted position (FIG. 5) proximate the rear end 206 of the end wall 212 to an extended position (FIG. 1) proximate the front end 204 of the floor 202.

Referring now to FIG. 7, the sledge 300 is shown including the upstanding wall 302 having the front side 302a and the back side 302b, the scraper 314 extending at an oblique angle from the front side 302a of the upstanding wall 302, and the mount 500 provided on the upstanding wall 302 for engaging the rail 216 (FIG. 6) to permit the sledge 300 to move from the retracted position to the extended position. As shown in FIG. 7, in embodiments, the sledge 300 may include a pair of mounts 500 provided on opposite sides of the upstanding wall 302. Each mount 500 may include a single caster 502 or a plurality of casters 502 that each engage a respective rail 216, as discussed in more detail herein.

As referred to herein, the retracted position is defined as a position where a distance between the sledge 300 and the rear end 206 of the floor 202 is less than a distance between the sledge 300 and the front end 204 of the floor 202. Conversely, the extended position is defined as a position where a distance between the sledge 300 and the rear end 206 of the floor 202 is greater than a distance between the sledge 300 and the front end 204 of the floor 202.

Referring again to FIGS. 5 and 7, the angle at which the scraper 314 is attached to the upstanding wall 302 may be the same angle as the protrusion 244 (FIG. 1). In such an embodiment, when the sledge 300 is in the retracted position, the upstanding wall 302 of the sledge 300 sits flush with the end wall 212 of the dumpster 200, and a back side 315 of the scraper 314 is able to sit flush with the protrusion 244. In embodiments, the upstanding wall 302 and the scraper 314 of the sledge 300 have a perimeter 310 and a guard 312 removably attached to the perimeter 310. The guard 312 may include a plurality of guard segments 313 which are removably attached to the upstanding wall 302 and the scraper 314. The guard segments 313 may be attached to the perimeter 310 of the scraper 314 in any suitable manner such as, for example, with screws, bolts, welding, or the like. The guard 312 assists the scraper 314 in removing waste material from the interior of the dumpster 200. In embodiments, the guard 312 is formed of plastic and contacts the interior surface 202a of the floor 202 and the sidewalls 208, 210. In embodiments, the material forming the guard 312 has a rigidity less than the material forming the interior surface 202a of the dumpster 200 so as to not damage the interior surface 202a. In embodiments, the scraper 314 has a substantially hexagonal shape. However, other geometries of the scraper 314 are within the scope of the present disclosure.

Referring again to FIG. 1, in embodiments, a cable 316 extends between a motor 102 provided on the end wall 212 of the dumpster 200 and the upstanding wall 302 of the sledge 300 to retract the sledge 300 from the extended position to the retracted position. In such an embodiment, the sledge 300 includes a loop 318, either formed in a front side 302a and/or the back side 302b of the upstanding wall 302, or other engaging mechanism to permit the cable 316 to engage the sledge 300. In embodiments, the motor 102 may be replaced with a hand crank, winch, or any other suitable device for engaging the cable 316 to position the sledge 300 between the retracted position and the extended position. In other embodiments, the sledge 300 may be positioned between the retracted position and the extended position due to the force of gravity when the dumpster 200 is tilted and positioned into the dumping position.

Referring again to FIG. 3, in embodiments, the sledge 300 includes one or more rollers 322 that are mounted to the bottom of the scraper 314 that make contact with and roll along the interior surface 202a of the floor 202 of the dumpster 200. The rollers 322 allow the scraper 314 to more easily move within the interior of the dumpster 200 between the retracted position and the extended position. In embodiments, the sledge 300 includes a single roller 322 mounted to the bottom of the scraper 314. In other embodiments, the sledge 300 includes a pair of rollers 322 mounted on opposite lateral ends of the back side 315 of the scraper 314. In other embodiments, as shown in FIG. 7, four rollers 322 may be provided on the lower surface of the sledge 300. It should be appreciated that additional rollers 322 may aid in stabilization of the sledge 300 moving along the dumpster 200.

Referring again to FIG. 6, the casters 502 facilitate the sledge 300 moving between the retracted position and the extended position within the dumpster 200. In embodiments, the casters 502 engage with the rail 216 having the V-shaped rib 242, the cylindrical rail, or the worm gear, as discussed herein. In other embodiments, the sledge 300 may include a motor 320 operably coupled to the mount 500 to move the sledge 300 between the retracted position and the extended position.

Referring still to FIG. 6, the mount 500 is shown including a plurality of casters 502 engaging the rail 216. When the casters 502 are interfaced with the rail 216, they can roll to position the sledge 300 between the retracted position and the extended position without any lateral movement which helps them stay in place. In embodiments, the motor 320 may be operably connected to the casters 502 to facilitate positioning the sledge 300 between the retracted position and the extended position. In other embodiments, the mount 500 includes an inner conduit that slidably engages the rail 216, which includes an outer conduit having a similar geometry to receive the inner conduit of the mount 500. As described herein, the rail 216 may include a worm gear, which may be operated by a motor, such as the motor 320. In such an embodiment, the mount 500 may include a nut or other similar mechanism for engaging the worm gear of the rail 216. As the worm gear is rotated by the motor 320, the sledge 300 moves between the retracted position and the extended position.

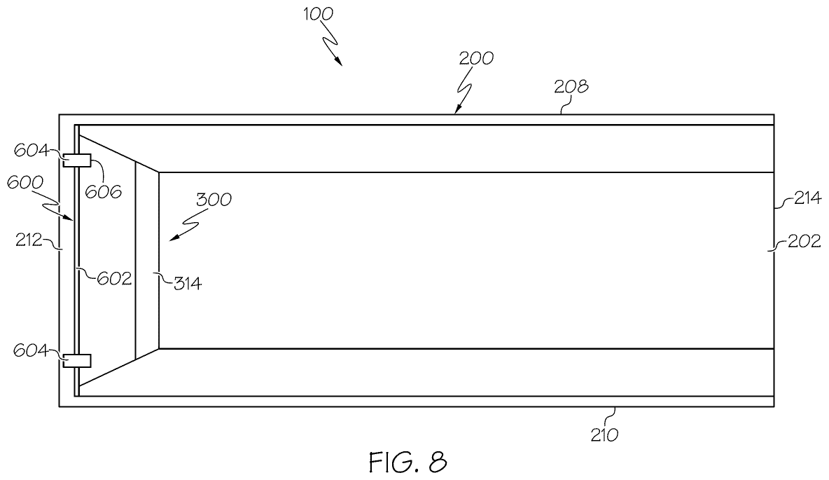

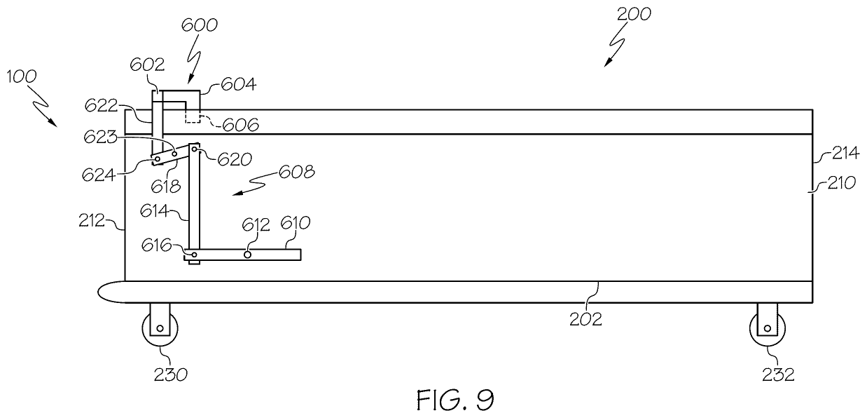

Referring now to FIGS. 8 and 9, an embodiment of a locking mechanism 600 for maintaining the sledge 300 in the retracted position is illustrated. In embodiments, the locking mechanism 600 includes an upper bar 602 extending above an upper surface of the end wall 212 of the dumpster 200 and one or more stoppers 604 extending from the upper bar 602. As shown in FIG. 8, the locking mechanism 600 includes a pair of stoppers 604. In embodiments, the stoppers 604 are fixed to the upper bar 602 and are L-shaped such that a leading end 606 of the stoppers 604 are directed into the dumpster 200 and toward the floor 202 of the dumpster 200.

As described in more detail herein, the locking mechanism 600 is operable between an unlocked state to permit movement of the sledge 300 and a locked state to inhibit movement of the sledge 300 from the retracted position to the extended position. With the locking mechanism 600 in the unlocked state, the stoppers 604 are in a raised position spaced apart from the upstanding wall 302 of the sledge 300, thus permitting the sledge 300 to move toward from the retracted position to the extended position. Alternatively, with the locking mechanism 600 in the locked state, the stoppers 604 are in a lowered position hooked around the upstanding wall 302 of the sledge 300 such that the sledge 300 is inhibited from moving from the retracted position to the extended position.

As shown in FIG. 9, the locking mechanism 600 includes a linkage assembly 608 pivotally coupled to the second sidewall 210 of the dumpster 200 for moving the upper bar 602 and thus the stoppers 604 between the raised position and the lowered position. In embodiments, the linkage assembly 608 includes one or more linkages. As shown, the linkage assembly 608 includes a first linkage 610 pivotally fixed to the second sidewall 210 at a first pivot 612, a second linkage 614 pivotally fixed to the first linkage 610 at a second pivot 616, a third linkage 618 pivotally fixed to the second linkage 614 at a third pivot 620 and pivotally fixed to the second sidewall 210 at fourth pivot 623, and a fourth linkage 622 pivotally fixed to the third linkage 618 at a fifth pivot 624. The upper bar 602 is fixed to an upper end of the fourth linkage 622 opposite the third linkage 618.

Accordingly, an operator is able to move the stoppers 604 between the raised position and the lowered position by raising or lowering an end of the first linkage 610 opposite the second linkage 614. Specifically, to place the locking mechanism 600 into the locked state such that the stoppers 604 are moved into the lowered position, an operator applies a pushing or downward force on the end of the first linkage 610 opposite the second linkage 614. The downward force causes the first linkage 610 to rotate in a clockwise direction about the first pivot 612, thus causing the second linkage 614 to move in an upward vertical direction. Movement of the second linkage 614 in the upward vertical direction results in pivoting of the third linkage 618 about the third pivot 620 in a counterclockwise direction and, thus, lowering of the fourth linkage 622 in a downward vertical direction. Accordingly, the upper bar 602 fixed to the upper end of the fourth linkage 622 moves in the downward vertical direction positioning the stoppers 604 in the lowered position to abut against the upstanding wall 302 of the sledge 300, thereby placing the locking mechanism 600 in the locked state. As noted above, with the locking mechanism 600 in the locked state and the stoppers 604 in the lowered position, the stoppers 604 hook around the upper edge of the upstanding wall 302 of the sledge 300 to inhibit movement of the sledge 300 from the retracted position to the extended position.

Alternatively, to place the locking mechanism 600 into the unlocked state such that the stoppers 604 are moved into the raised position, an operator applies a lifting or upward force on the end of the first linkage 610 opposite the second linkage 614. The upward force causes the first linkage 610 to rotate in a counterclockwise direction about the first pivot 612, thus causing the second linkage 614 to move in a downward vertical direction. Movement of the second linkage 614 in the downward vertical direction results in pivoting of the third linkage 618 about the third pivot 620 in a clockwise direction and, thus, raising of the fourth linkage 622 in an upward vertical direction. Accordingly, the upper bar 602 fixed to the upper end of the fourth linkage 622 moves in the upward vertical direction positioning the stoppers 604 in the raised position to be spaced apart from the upstanding wall 302 of the sledge 300, thereby placing the locking mechanism 600 in the unlocked state. As noted above, with the locking mechanism 600 in the unlocked state and the stoppers 604 in the raised position, the stoppers 604 are spaced apart from the upper edge of the upstanding wall 302 of the sledge 300 to permit movement of the sledge 300 from the retracted position to the extended position.

It should be appreciated that the above description of the locking mechanism 600 refers to manual operation of the locking mechanism 600 and specifically operation of the first linkage 610 to position the stoppers 604 between the raised position and the lowered position to control movement of the sledge 300. However, other embodiments of the locking mechanism 600 are contemplated. For example, the linkage assembly 608 may include a fewer or greater number of linkages other than that depicted in FIG. 9 and described herein. For example, the linkage assembly 608 may include only a single linkage movable in a vertical direction to control a position of the stoppers 604. In other embodiments, the linkage assembly 608 may be provided at any suitable location of the dumpster 200 such as, for example, at the end wall 212 of the dumpster 200 or proximate the door wall 214 of the dumpster 200. Additionally, in other embodiments, the stoppers 604 may be rotatably coupled to the linkage assembly 608 and/or the upper bar 602 such that the stoppers 604 rotate relative to the upstanding wall 302 of the sledge 300 to hook around the upper end of the upstanding wall 302 or rotate out of the way. Further, automated embodiments are contemplated in which the locking mechanism 600 may be operated remotely such as, for example, within a cab of a vehicle or wirelessly from outside of a vehicle via a handheld device or the like. In doing so, the locking mechanism 600 may include one or more actuators and/or motors for controlling movement of any of the components of the linkage assembly 608 or the stoppers 604 themselves.

From the above, it is to be appreciated that defined herein is an apparatus including a dumpster and a sledge moveable within the dumpster to facilitate removing residue from an interior of the dumpster.

While particular embodiments have been illustrated and described herein, it should be understood that various other changes and modifications may be made without departing from the scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

What is claimed is:

1. An apparatus comprising:
a dumpster comprising:
a floor having an interior surface, an exterior surface opposite the interior surface, a front end, and a rear end;
a first sidewall having an interior surface and extending upwardly from the floor;
a second sidewall having an interior surface and extending upwardly from the floor opposite the first sidewall;
an end wall extending between the first sidewall and the second sidewall, and upwardly from the rear end of the floor;
a door wall that is movably attached to one of the first sidewall and the second sidewall at the front end of the floor; and
a rail extending along the interior surface of at least one of the first sidewall and the second sidewall between the front end and the rear end of the floor; and
a sledge comprising:
an upstanding wall having a front side and a back side;
a scraper extending at an oblique angle from the front side of the upstanding wall and contacting the interior surface of the floor; and
a mount provided on the upstanding wall and engaging the rail to permit the sledge to move from a retracted position proximate the rear end of the end wall to an extended position proximate the front end of the floor.

2. The apparatus of claim 1, wherein the sledge further comprises a guard removably attached to a perimeter of the upstanding wall and a perimeter of the scraper, the guard comprising a plurality of guard segments removably attached to the perimeter of the upstanding wall and a perimeter of the scraper.

3. The apparatus of claim 1, wherein:
in the retracted position, a distance between the sledge and the rear end of the floor is less than a distance between the sledge and the front end of the floor; and
in the extended position a distance between the sledge and the rear end of the floor is greater than a distance between the sledge and the front end of the floor.

4. The apparatus of claim 1, wherein the rail defines a recess formed in at least one of the first sidewall and the second sidewall and a rib is provided in the recess, where the rib is substantially v-shaped.

5. The apparatus of claim 4, wherein the mount comprises a caster extending from at least one of the first sidewall and the second sidewall and engages the rib of the rail.

6. The apparatus of claim 1, further comprising a cable extending between the end wall of the dumpster and the upstanding wall of the sledge.

7. The apparatus of claim 6, further comprising a hand crank engaging the cable operable to position the sledge between the retracted position and the extended position.

8. The apparatus of claim 6, further comprising a winch engaging the cable operable to position the sledge between the retracted position and the extended position.

9. The apparatus of claim 5, wherein the mount further comprises a motor operable to rotate the caster and move the sledge between the retracted position and the extended position.

10. The apparatus of claim 1, further comprising a locking mechanism for maintaining a position of the sledge in the retracted position.

11. The apparatus of claim 10, wherein the locking mechanism comprises one or more stoppers positionable between a raised position to be spaced apart from the upstanding wall of the sledge, and a lowered position to abut against the upstanding wall of the sledge to prevent movement of the sledge from the retracted position to the extended position.

12. The apparatus of claim 11, further comprising a linkage assembly for positioning the one or more stoppers between the raised position and the lowered position, wherein the linkage assembly is provided on an exterior surface of one of the first sidewall and the second sidewall.

13. An apparatus for the storage and transporting waste material comprising:
a dumpster including:
a floor;
a pair of opposing sidewalls;
a rail provided on and extending substantially a length of each of the sidewalls;
an end wall; and
a door wall pivotably mounted to at least one of the sidewalls or floor,
wherein the floor, the sidewalls, and the end wall define an interior of the dumpster and an open top for the dumpster to permit waste material to be deposited into the dumpster,
wherein the door wall is movable between a first position closing the dumpster and a second position to open to the interior of the dumpster; and
a sledge positionable within the interior of the dumpster and configured to extend between the sidewalls of the dumpster, the sledge being positioned on the rails and movable along the rails between the end wall and the door wall,
wherein when door wall is placed in the second position and the dumpster is inclined, the sledge operates to move toward the door wall and away from the end wall to reject waste material in the interior out of the dumpster.

14. A sledge comprising:
an upstanding wall having a front side and a back side;
a scraper extending at an oblique angle from the front side of the upstanding wall; and
a mount provided on at least one side of the upstanding wall, the mount configured to engage a rail of a dumpster.

15. The sledge of claim 14, further comprising a guard removably attached to a perimeter of the upstanding wall and a perimeter of the scraper, the guard comprising a plurality of guard segments removably attached to the perimeter of the upstanding wall and a perimeter of the scraper.

16. The sledge of claim 14, wherein the mount comprises a caster.

17. The sledge of claim 16, wherein the mount further comprises a motor operable to rotate the caster.

18. The sledge of claim 14, wherein the mount further comprises a plurality of casters.

19. The sledge of claim 18, wherein the plurality of casters are mounted on opposite sides of the upstanding wall.

20. The sledge of claim 14, wherein the scraper comprises a roller attached to the bottom of the scraper.
